(19) United States
(12) Patent Application Publication
(10) Pub. No.: US 2018/0218324 A1
(43) Pub. Date: Aug. 2, 2018

(54) Systems and Methods of Operation for Facilitating Workplace Communication

(71) Applicant: Carolyn Friebner-Mueller, Chattanooga, TN (US)

(72) Inventors: Carolyn Friebner-Mueller, Chattanooga, TN (US); Jens Friebner-Mueller, Chattanooga, TN (US)

(21) Appl. No.: 15/417,385

(22) Filed: Jan. 27, 2017

(51) Int. Cl. G06Q 10/10

(52) U.S. Cl. CPC G06Q 10/103

(57) ABSTRACT

A system, apparatus and method are provided for the pervasive use of personality type information throughout an organization, by inputting the information into a system and sign apparatus facilitating the ongoing use of personality classification in peer-to-peer and group meeting situations and providing an information channel for consultant contributions to facilitate communications between personality types.

### PRIOR APPLICATIONS

The present application claims priority to U.S. Provisional Application Ser. No. 62/034,116, filed Aug. 6, 2014, and PCT Application No. PCT/US15/44107, filed Aug. 6, 2015, both of which are incorporated herein.

### FIELD OF THE INVENTION

The present invention relates to the facilitation of workplace communication, and systems and apparatus for collecting and presenting information particularly useful to co-workers in collaborative settings.

### BACKGROUND OF THE INVENTION

In the modern workplace, oftentimes co-workers are called upon to interact without any significant prior working relationship. This is attributable to many factors including, among others, the number of employees in some businesses, a mobile workforce with significant turnover from one location to another or between different employers, and less time being spent in a common office due to travel and work at home policies. In addition, open plan work areas with undefined hierarchical relationships between co-employees contribute to friction in beginning new work relationships.

According to some reports, nearly 80% of Fortune 500 companies use personality tests to assess potential and current employees in order to make hiring, team building, and developmental decisions. Some of the most common and widely used personality tests that we see today include Myers-Briggs Type Indicator (MBTI), Caliper Profile, Hogan Assessments, StrengthsFinder, and DiSC, DeBono, DOPE, Birkman Method, Standout, Color Code, Personality Plus, 5 Love Languages, DOPE, Caliper Profile, Judgment Index, Predictive Index, firoB, 16PF, True Colors, Lerning Styles, PMAI, Big Five, Occupational Interest Inventories (OIIs), and Situational Judgment tests (STJs), among others. In recent years, psychologists and human resources practitioners have suggested the use of personality testing as a tool to assist in making better and more informed hiring and developmental decisions.

Employers use the results of personality tests to improve the work environment. For example, personality tests can measure communication styles. Learning the differences among these styles helps organizations develop programs and workplace rules that minimize conflict and improve communication among co-workers themselves and between workers and management. For example, the Myers-Briggs “thinking” and “feeling” scale measures how individuals evaluate information and make decisions. While a “thinking” individual prefers fairness, objectivity and truth, a “feeling” individual may value compassion and harmony in work relationships. These two styles may clash, for example, when a “thinking” supervisor delivers a seemingly objective performance review to a “feeling” employee that perceives the review as caustic or severely critical.

Personality types explain the dominant function or preference of an individual and tell employers and project managers how individuals structure thoughts, attitudes, reach conclusions and interact. These personality types are often described in terms of team roles in the workplace, such as the “Actor,” “Executive,” “Coach,” “Persuader” or “Analyst,” each with a different strength and weakness. Each personality type also has an interaction style, such as a “Leader” or “Motivator.” Employers and supervisors that understand these styles and team roles can leverage the strength of one employee to fill the weakness of another, developing teams that can interact effectively with one another, work to meet deadlines and complete tasks.

Employers can use personality test results to develop leaders, such as executives and directors. Some personality tests, such as The Birkman Method, help identify candidates who need more experience or who are ready for leadership. The Birkman Method also identifies certain behaviors, workplace needs and reactions to stress. Using this information, organizations can decide which leadership qualities to nurture in their leadership development programs and the training needs of individuals. For example, organizations may develop a “fast track” program for candidates who measure high on certain personality scales. They also can tailor curricula to the individual, emphasizing and developing qualities in candidates who may have measured low on a specific trait.

In addition to providing management with an understanding of personality types, an individual's understanding of their own personality type and the personalities of co-workers can be beneficial at many levels. Many work teams and even sports teams, use personality tests to help the team members learn more about each other. Since the personality test indicates some of the co-workers' innate preferences, it can be very useful for other team members to understand how each individual is predisposed to act.

Personality tests can also be used as a tool to help dysfunctional teams learn more about each other and begin to work through some of their differences. Each team member would take the same personality test and then would share their results with the other members of the team. Then, as a team, they would discuss the results and how to function as a more cohesive team.

Increasing the teams' awareness of the personality types of the other members can create a more functional and cohesive team atmosphere. Once the team members realize that someone has a different personality type that might make them more suited to one type of communication than the other, they can adapt and work together to create the best team dynamics. Personality tests can be a great tool to use to bring team members together and create more productive teams

Similarly, the personality type can help alert an individual to possible negative behaviors, and suggest appropriate developmental training. By taking a personality test, an individual can often learn about themselves and encourage self-awareness. For example, if a job involves presenting speeches and mingling with large crowds of people, but an individual has always felt uncomfortable performing those job functions, awareness of a naturally introverted personality can help the individual to better understand and cope with these tasks. The introverted personality type will realize that performing these social functions are unusually exhausting. By making this realization, the introverted worker will be better able to cope with their job and maintain a positive outlook. For example, an introvert might be coached that they will function better in social settings by spending some quiet time alone before the functions to gather energy.

Personality tests and quizzes can also provide insight into how individuals react to other people. For example, certain personality types have a tendency to get along better, while other personality types often are prone to arguments and clashes of style and opinion.

Although the use of various personality inventory tools and testing have become widely accepted practices in improving various practices in the workplace, generally these uses are quite discrete. For instance, a personality inventory may be a part of the hiring process, but is not utilized by managers in forming or directing teams. Or consultants may inventory employees in a team setting, or within a department, and provide coaching over a short term, but there is no systematic repetition or refreshing of this information, leading to a great diminution in its value as various employees are promoted or otherwise replaced.

To facilitate the use of personality inventory tools in the workplace, a system, apparatus, and methods have been developed to integrate the individual into the work environment, using, in some embodiments, displays with adaptable elements for offices and any work environments to increase identification and optimize communication, collaboration and therefore increase a company's effectiveness. The system, apparatus, and method may serve as a tool set that increases the identification of the employees with their companies and enables formation of high functioning and highly effective teams, in part by providing symbolic signs/icons and methods and apparatus to display these icons. In this way, the organization brings back a human aspect to the business world, empowering their employees to contribute significantly to their company, not just in connection with discrete evaluations and personality consulting engagements, but as a holistic employer engagement with the value of understanding and utilizing the advantages of diverse personalities within the organization. The use of visual displays brings to light information about the individual that is helpful for increased effectiveness. The information helps contribute positively to the interaction between employees as well as their management. Other displays may address conflict resolution in a productive manner, and provide a system to establish a company specific culture on how to handle and solve conflict. The result is the integration of all employees for the greater good of the organization.

The system, apparatus and method can be appreciated by a discussion of and exemplary set of visual icons or dictionary for facilitating workplace interaction, an explanation of how the data is collected to display this information, how the data is stored and accessed, and a number of examples of how the information is displayed in different settings. The types of information collected focuses on the employee and the employer, but may include contributions from both internal and external consultants. Therefore, the visual displays focus on work-related personal traits as well as non-work-related personal traits.

### BRIEF SUMMARY OF THE INVENTION

Various aspects of the invention may include one or more of a method for collecting personality assessment information from various sources and organizing and attributing ownership of this information, apparatus to facilitate the method and to display personality assessment information, and an automated system on which the method may be implemented.

### BRIEF DESCRIPTION OF THE DRAWINGS

Particular features and advantages of the present invention will become apparent from the following description when considered in conjunction with the accompanying drawings in which:

FIG. 1 depicts an exemplary set of 53 icons that may be used in an embodiment of the system.

FIGS. 2A through 2F are employee sign up screens utilized for registration and participation in an employer or other sponsored personality assessment system.

FIG. 3A is a computer screen display representing the iconography associated with an example employee registration.

FIG. 3B is a smart phone display format for employee personality assessment information.

FIG. 3C is an alternative smart phone representation of an employee registration with personality assessment information but also emphasizing employee contact data.

FIG. 3D represents employee personality assessment information as would be displayed on internal company digital phone systems.

FIG. 4A is representative apparatus that can be utilized with a base plate, changeable name plate, and rotatable display wheels with icons visible through slots in the base plate.

FIG. 4B represents a simplified display apparatus with printed or snap-in icons and name plate.

FIG. 4C represents a more extensive personality assessment sign apparatus with printed or snap-in icons and name information.

FIG. 5 depicts merchandise including hats, clothing, temporary tattoos, buttons, pendants, awards, and accessories such as bags and backpacks, jewelry and accessories displaying personality related icons.

FIG. 6A is a schematic representation of a preferred data model for implementing a method and system to utilize personality assessment information.

FIG. 6B is a representation of simplified data blocks utilized in an implementation of a system and method to utilize personality assessment information.

FIG. 6C is an alternative representation of the basic data blocks or structures utilized in the data models of FIGS. 6A and 6B.

FIG. 7 is a simplified optimal network structure for implementing a method and system for utilizing personality assessment information.

FIG. 8 depicts an exemplary employee data screen that may be utilized in a distributed personality assessment system and method.

FIG. 9 represents an alternative exemplary employee leader screen for use in a distributed personality assessment system and method.

FIG. 10 depicts an exemplary meeting leader or consultant screen for use in a distributed personality assessment method and system.

FIG. 11 represents an exemplary employer screen to facilitate company access to employee data maintained in a personality assessment system database.

FIG. 12 depicts an exemplary consultant screen for use by consultant in providing services to a company with a distributed personality assessment system.

FIG. 13 is a first chart of preparatory steps prior to implementation of a personality assessment system and method of an employer.

FIG. 14 illustrates a flow chart of an exemplary interpretive process in which employee input contributes to development of an effective corporate personality assessment system and methods.

FIG. 15 is a flow chart illustrating the interface of a consultant with database for personality assessment system.

### DETAILED DESCRIPTION OF THE INVENTION

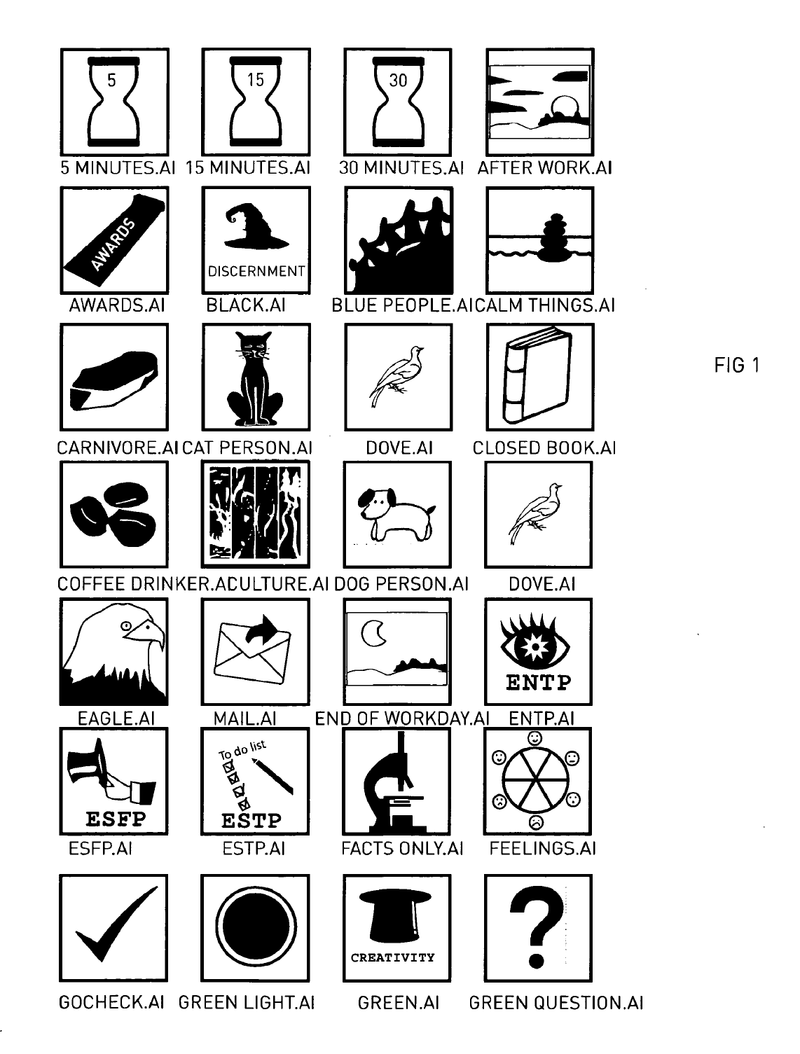

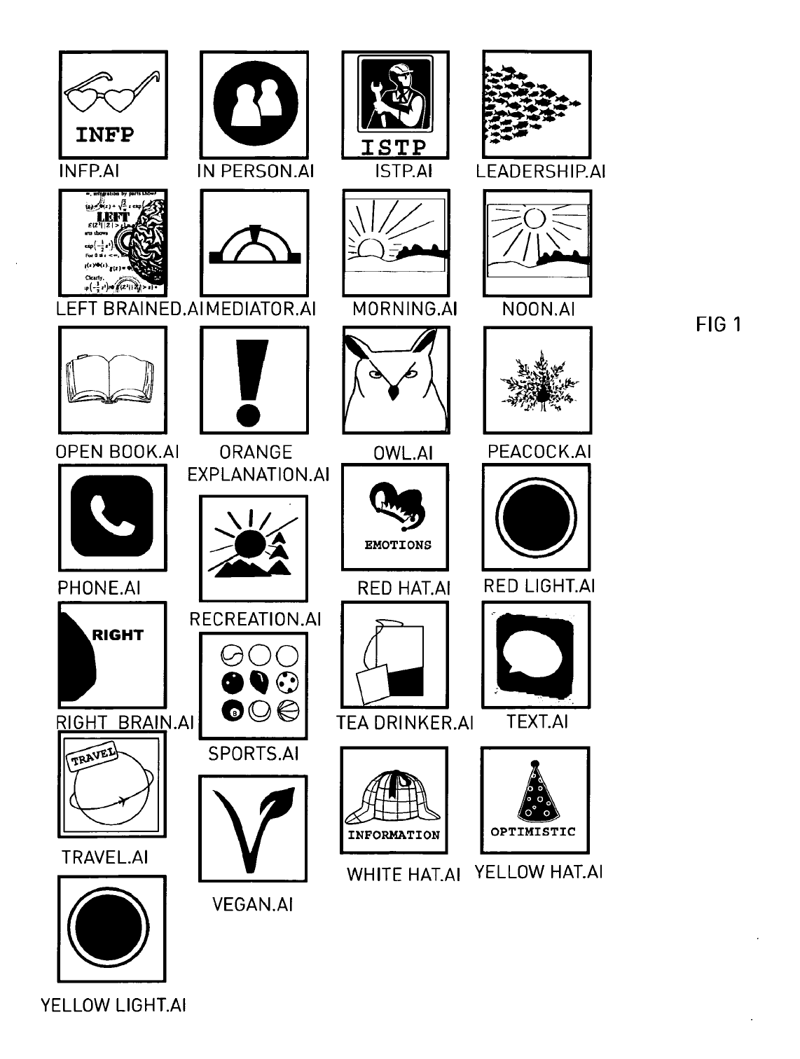

The system contemplates the receipt of data as a result of personality assessment testing (either directly from an administering employer or from a consultant), together with various largely factual data from the employer, data volunteered from employees, and contributions from consultants. An exemplary starting point for describing the system is with the delivery of personality assessment testing results to an employee. The delivery is preferably made electronically through the system, but could be accomplished in paper, as was the case for many years, with a booklet that explained the results. The employer also will decide upon a system of icons to convey the personality assessment information and other personality information that will be utilized in that employer's system. FIG. 1 reflects 53 exemplary icons that might be utilized in such a system, however, due to the variety of employer types and differing personality assessment tests, icons will be customized to some extent for each employer. Referring now to the drawings in more detail, FIG. 1 generally depicts icons selected to represent personality dimensions according to established or company specific categories, company organizational structure, company specific systems and awards, conflict resolution related information, communication styles, collaboration preference, and personal interests as itemized in more detail below.

Organizational Structure & Organizational Process (for Example)
My boss, I report to
Goals, Roles, Responsibilities
My customers' expectations
Departmental assignment: i.e. Product development, design,
My internal customer is:
I have open questions
I need materials, equipment (I have all materials and equipment to do my job)
Received recognition in past 7 days.

Established Structured Methods (for Example)

De Bono's 6 Thinking Hats [de Bono, Edward (1985). Six Thinking Hats: An Essential Approach to Business Management.

White Hat=Information: considering purely what information known or needed. What are the facts?

Yellow Hat=Optimistic Response: logic applied to identifying benefits, seeking harmony. The Yellow Hat symbolizes brightness and optimism. Under this hat you explore the positives and probe for value and benefit.

Black Hat=Discernment: logic applied to identifying reasons to be cautious and conservative. The Black Hat is judgment—the devil's advocate or why something may not work. Spot the difficulties and dangers; where things might go wrong. Probably the most powerful and useful of the Hats but a problem if overused.

Red Hat=Emotions: intuitive or instinctive gut reactions or statements of emotional feelings, hunches and intuition. When using this hat you can express emotions and feelings, share fears, likes, dislikes, loves and hates.

Green Hat=Creativity: Statements of provocation and investigation, seeing where a thought goes. The Green Hat focuses on creativity; the possibilities, alternatives, and new ideas. It's an opportunity to express new concepts and new perceptions.

Blue Hat=is used to manage the thinking process. It is the control mechanism that ensures the 6 Thinking Hats guidelines are observed.

Sequences always begin and end with the blue hat; the group agrees together how they will think, then they do the thinking, then they evaluate outcomes of that thinking and what they should do next.

MBTI [Myers, Isabel Briggs with Peter B. Myers (1980, 1995). Gifts Differing: Understanding Personality; Myers, Isabel Briggs; McCaulley Mary H.; Quenk, Naomi L.; Hammer, Allen L. (1998). MBTI Manual (A guide to the development and use of the Myers Briggs type indicator)]

INFP—The Idealist: Idealistic, loyal to their values and to people who are important to them. Want an external life that is congruent with their values. Curious, quick to see possibilities, can be catalysts for implementing ideas. Seek to understand people and to help them fulfill their potential. Adaptable, flexible and accepting unless a value is threatened.

ISTP—The Mechanic: Tolerant and flexible, quiet observers until a problem appears, then act quickly to find workable solutions. Analyze what makes things work and readily get through large amounts of data to isolate the core of practical problems. Interested in cause and effect, organize facts using logical principles, value efficiency.

ESFP—The Performer: Outgoing, friendly, and accepting. Exuberant lovers of life, people, and material comforts. Enjoy working with others to make things happen. Bring common sense and a realistic approach to their work, and make work fun. Flexible and spontaneous, adapt readily to new people and environments. Learn best by trying a new skill with other people.

ESTP—The Doer: Flexible and tolerant, they take a pragmatic approach focused on immediate results. Theories and conceptual explanations bore them they want to act energetically to solve the problem. Focus on the here-and-now, spontaneous, enjoy each moment that they can be active with others. Enjoy material comforts and style. Learn best through doing.

Other MBTI types include: ESTJ, ISTJ, ESTP, INTP, ENTJ, INTJ, ENFJ, INFJ, ENFP, ISFP, ESFJ, and ISFJ.

Personality Dimensions with Example Symbols

Inquiring Green—Knowledge and Competence

Characteristics: Logical and rational, quality conscious, improvement oriented, analytical and systematic, investigative and inquisitive, seeks the big picture, emotionally self-controlled, strategic thinker, innovative and ingenious, needs independence, requires private time, sets high expectations & standards.

Strengths: Determination, Conceptual skills, global and strategic thinking, absorbing and storing knowledge, clarity of thought and precise language, seeking comprehensive information, drawing insightful conclusions from complex information, analytical ability, establishing standards, big picture perspective, contributing optimum effort, systematic and logical approach gathering data and information.

Organized Gold—Belonging Through Duty & Responsibility

Characteristics: Organized and orderly, maintains traditions, responsible and practical, dependable and reliable, loyal to organizational goals, always prepares, service oriented, helpful and trustworthy, completes tasks on time, strong belief in policy and procedure, respects authority and rules, patient and cooperative. Strengths: dependability and stick-to-itiveness, seeks closure and follows through, strong sense of right and wrong, focuses on productivity, attention and concern for detail organization and planning skills, stabilizer to the organization, honors time-lines, provides and maintains order, cooperative and willing to help out, good quality and quantity of work, caretaker of group maintenance, weighs consequences before acting, possesses common sense.

Authentic Blue—Relationships & Self-Actualization

Characteristics: People-oriented, relates well to others, makes a favorable impression, creates cohesive environment, enthusiastic and stimulating, sensitive to the needs of others, supportive, empathetic, inspirational, expressive and animated, seeks and appreciates harmony, ethical, honest, and sincere, concerned for others, optimistic

Strengths: Ability to persuade and cooperate, communicates empathy, quick to offer praise and support, creative thinker, dedicated to people issues, mediates and resolves conflict, facilitates personal and organizational growth and development, natural team builders/players, sees/promotes potential in others, expresses thoughts and feelings, good intuition and imagination, fosters harmony, inspires and motivates others.

Resourceful Orange—Freedom, Activity & Variety

Characteristics: Seeks change and variety, action-oriented doer, makes quick decisions, independent and competitive, extremely generous, quick witted and funny, seeks new ways to do things, takes initiative, realistic, practical risk-taker, eager to try new things, open and non-judgmental.

Strengths: Flexible, adaptable, resilient, troubleshooting and problem-solving, clear, direct communicator, determination and drive, decisive and quick to act, thinks well on the spot, expedites and makes things happen, appreciates and gets quick results, excellent in crisis situations, endurance and stamina, performs well under pressure, natural instinct for opportunity, sees facts and realities, easy-going and entertaining.

Company Specific Systems/Categories (for Example)
Coffee vs. Tea; Mac vs. PC
Awards

Conflict Resolution (for Example)
Open vs. Closed
Preferred time: in am, lunch time, end of workday, Monday morning, Friday afternoon
Time Frame: 5 min, 15 min, (sec, min, hours)
Preferences for Conflict Resolution
Setting: Meeting room, while walking, off-site, over coffee
How=Feedback Structure: Mediator, Facts only, Emotional—feelings
Contact Preferences & Availability (for example)
Traffic light: green (immediate availability), yellow, red
morning, after lunch,
available/unavailable

Communication Preferences (for Example)
E-mail
Phone
Face to face

Availability to Others (for Example)

Traffic Light

1. Green: have time

2. Yellow: am working on something but can be briefly interrupted

3. Red: come back later

Personal Areas of Interest (for Example)
Family
Hobbies
Sports, music, etc.
Recreation/Outdoors
Culture: Enjoys music, theatre, dance, museums, etc.
Travel: Enjoys travel.
Sport: Enjoys participating in sport activities.
Calm Things: Enjoys reading, meditation, gardening, anything calm.
Other: This section can be as broad or specific as desired. For instance, it can be “Sports” or “Skiing” or a favorite team or anything else.

What Energizes Me? (for Example)
Yoga
Singing

Organizational Structure & Organizational Processes:

I report to ______

I'm in ______ team

I'm in:
Department
Product Development
Design
Customer Service
Sales
My Internal customer is:
Product Development Customer
Design Service
Sales
Open Question: I have open questions important to my tasks.
Need Materials: I need materials to for my work
Have Materials: I have all materials I currently need for my work to for my work
Recognition: I have received sufficient recognition for doing a good job within the last 7 days.

Collaboration Preferences: (for Example)

1. Brainstorming

2. Development

3. Design

4. Strategic Focus

5. Tactical Focus

6. Support Function

Work arrangement: team 100%—individual 0%; team 30%—individual 70%;

Place, environment: Office, cafeteria, outside,

Project phase: big picture planning—detail planning—executing—supporting—administrative—research.

Kind of work to contribution: creative—following orders—follow up on action items.

Role area: technical area, subject matters expert, organizing subjects, people organizing, facilitating, arbitrator,

Conflict Resolution:

Open: Open to discussing any conflicts concerning work place. Minimizing harmony terror minimal.

Closed: not open for discussion (at this time?)

When=Preferred Time:

1. In the morning

2. Lunch time

3. End of workday

4. Monday morning

5. Friday afternoon

Preferred Time Frame=Length:

1. 5 min

2. 15 min

3. 30 min

Setting=

1. Meeting room

2. While walking

3. Off site

4. Over coffee

5.

How=Feedback Structure:

1. Mediator

2. Facts only

3. Emotional

Awards:

Awards & Recognitions, Certifications,

Company Specific Identifications/Categories:

Leadership

Right Brained

Left Brained

Vegetarian

Carnivore

Cat Owner

Dog Owner

Introvert

Extrovert

Y′All

You Guys

MAC

PC

Tea Drinker

Coffee Drinker

Romantic Comedy

Sci-Fi

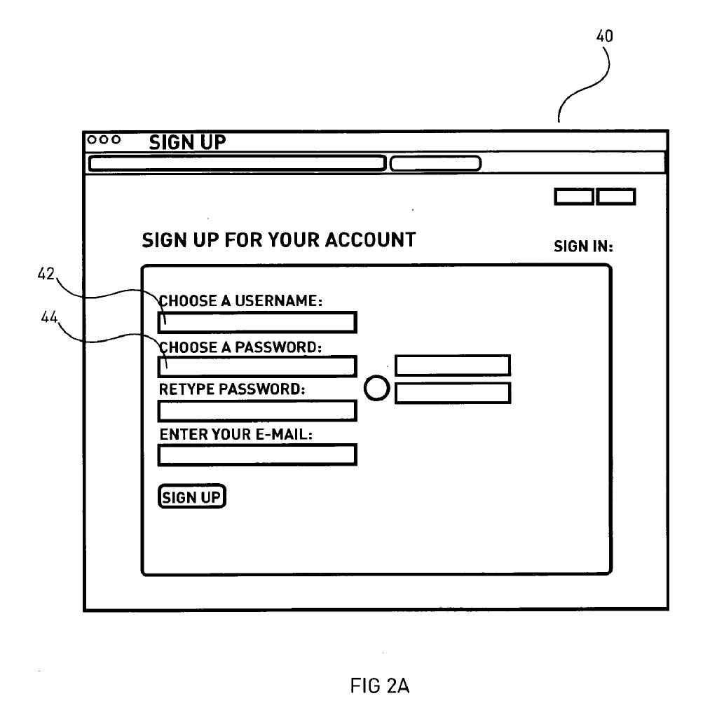

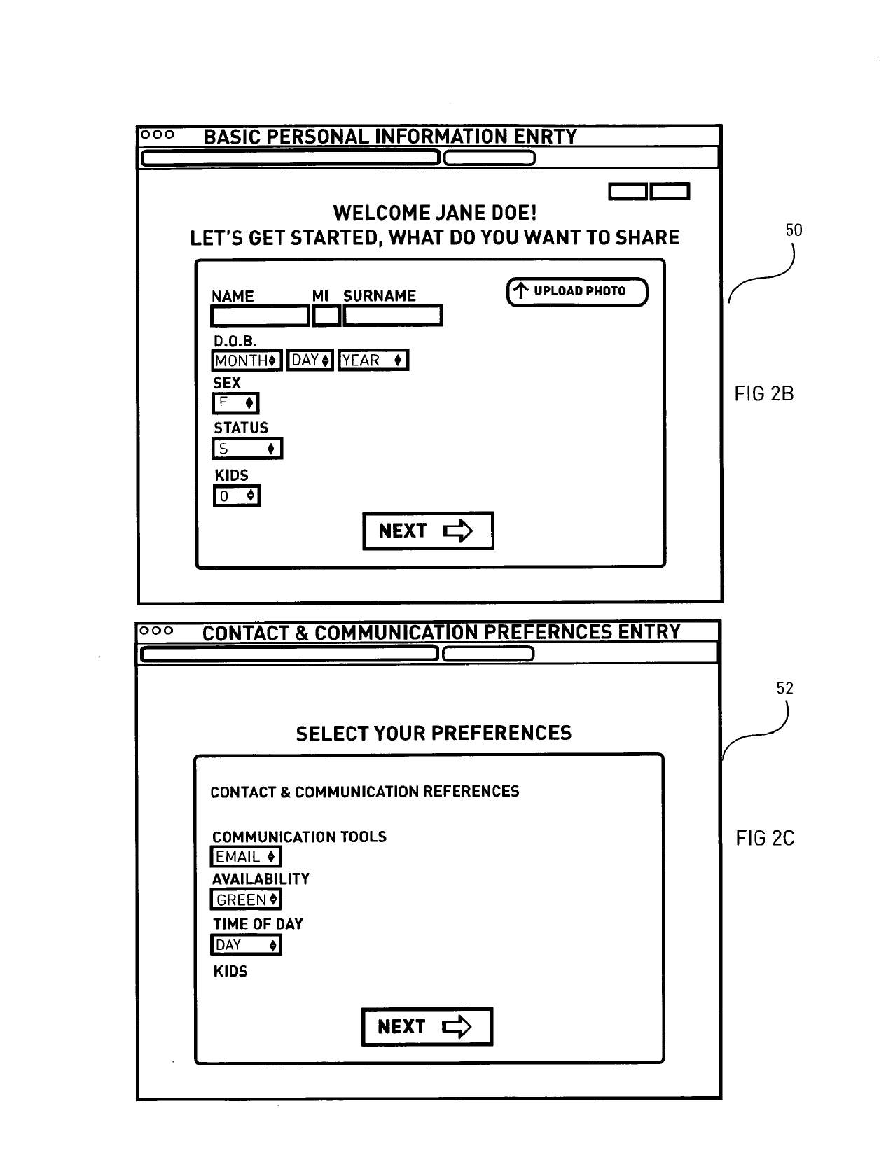

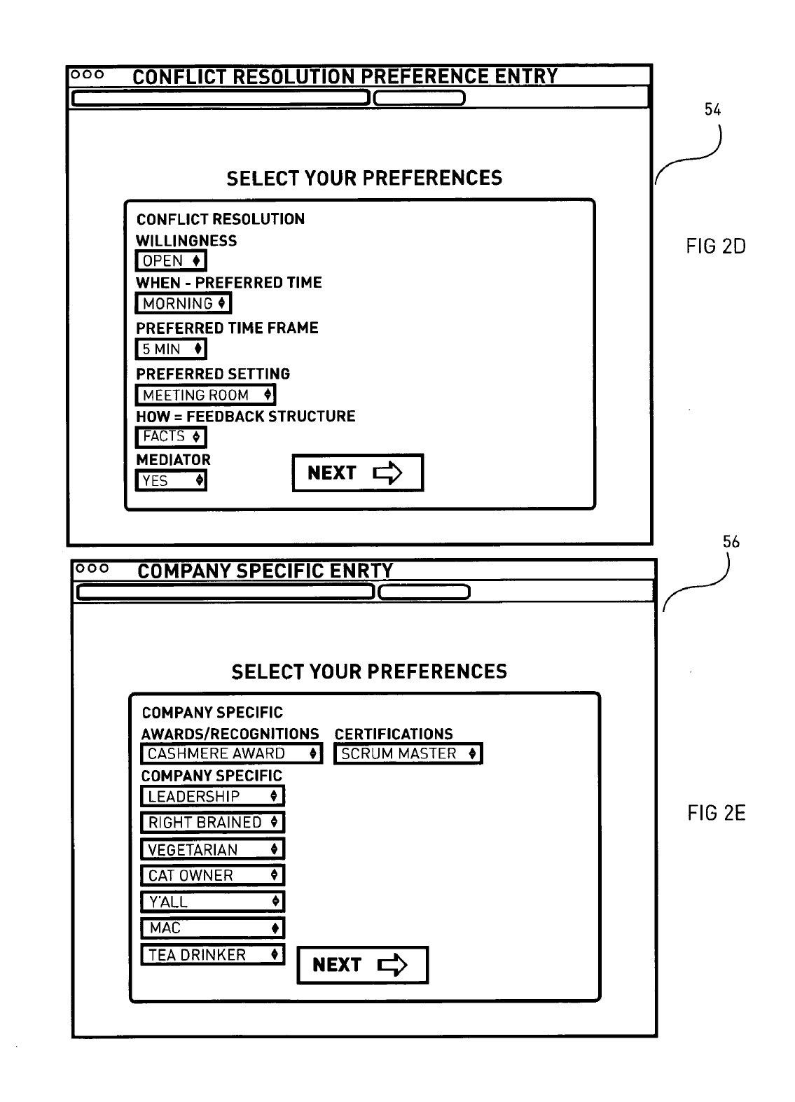

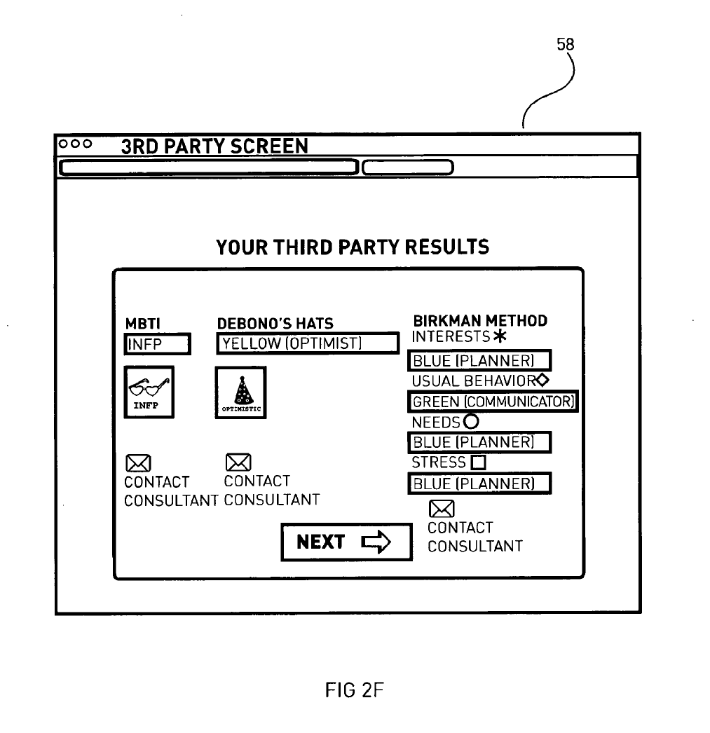

Once an organization's iconography is determined, employees may sign into an automated system to generate an individualized sign apparatus. Exemplary interface screens for employee use are depicted in FIGS. 2A through 2F. FIG. 2A represents the initial sign-in screen 40 where an employee establishes their user name 42 and password 44. The subsequent screens, or equivalent data collection screens or forms could be utilized by an employer, by an individual signing up directly with the system, or by a third party service. In FIG. 2B, a screen 50 for basic personal identification collects basic personal information, and in FIG. 2C, a contact information screen 52 collects communication preferences. FIG. 2D illustrates a screen 54 to collect conflict resolution preferences, a representative custom screen 56 is shown in FIG. 2E to collect company specific information, and the personality assessment screen 58 in FIG. 2F collects personality assessment results which may be input by the employee or prepopulated as a result of company or consultant testing. Depending upon the employer, additional information types may be included as described above.

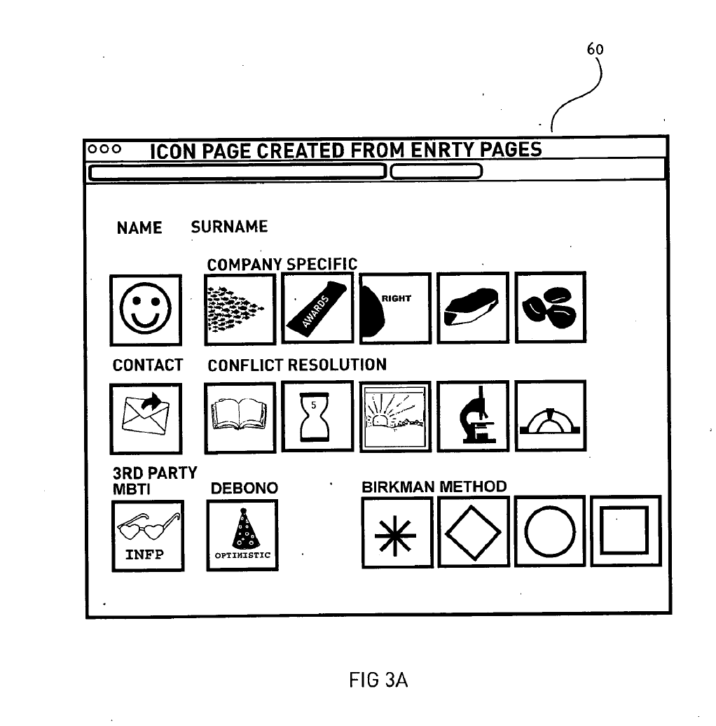

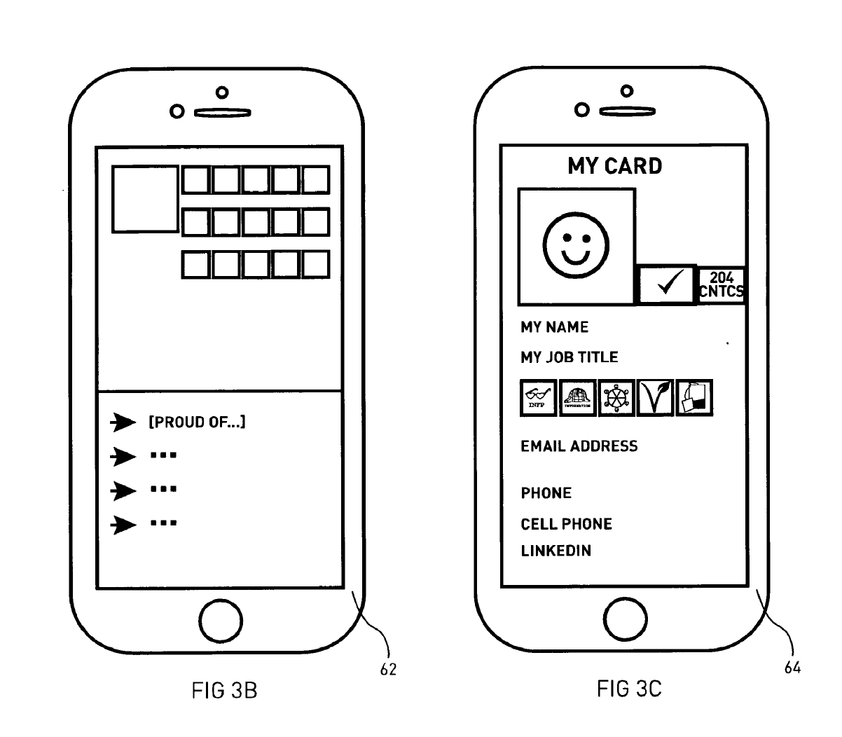

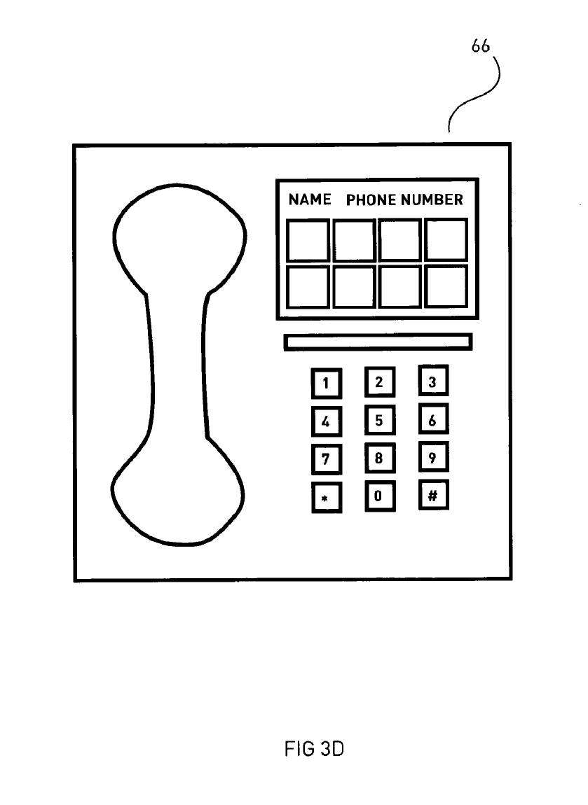

As a result of the employee input of this information, a screen 60 is generated utilizing company specific icons as depicted in FIG. 3A. Variations of this employee specific screen may also be adapted to be displayed on smart phones as typified in an icon emphasized format 62 in FIG. 3B or an employee data emphasized format 64 in FIG. 3C or a reduced sized format 66 suitable for use on organization (employer) IP phones in FIG. 3D.

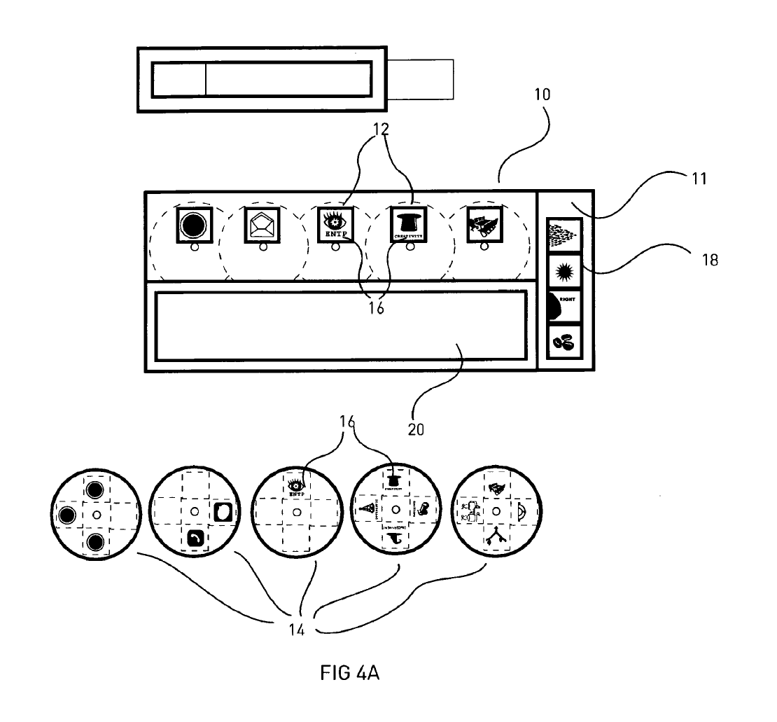

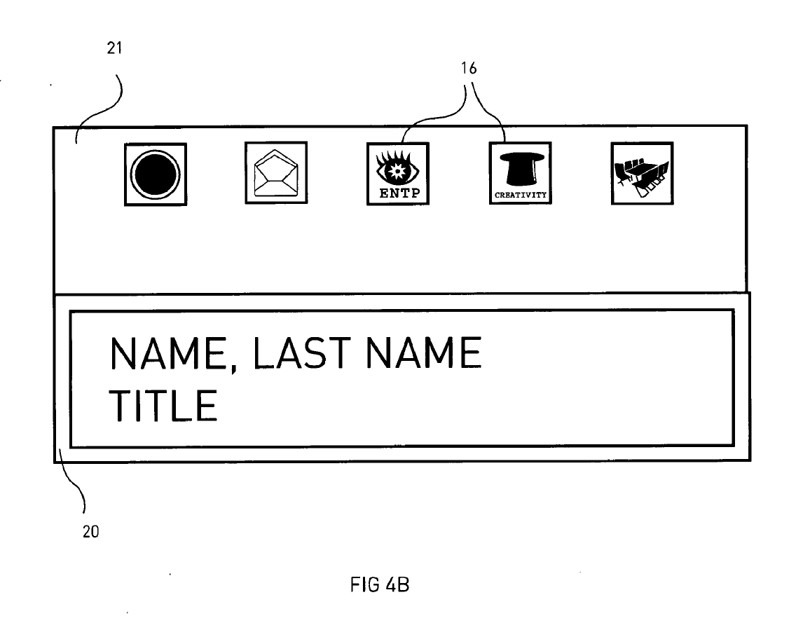

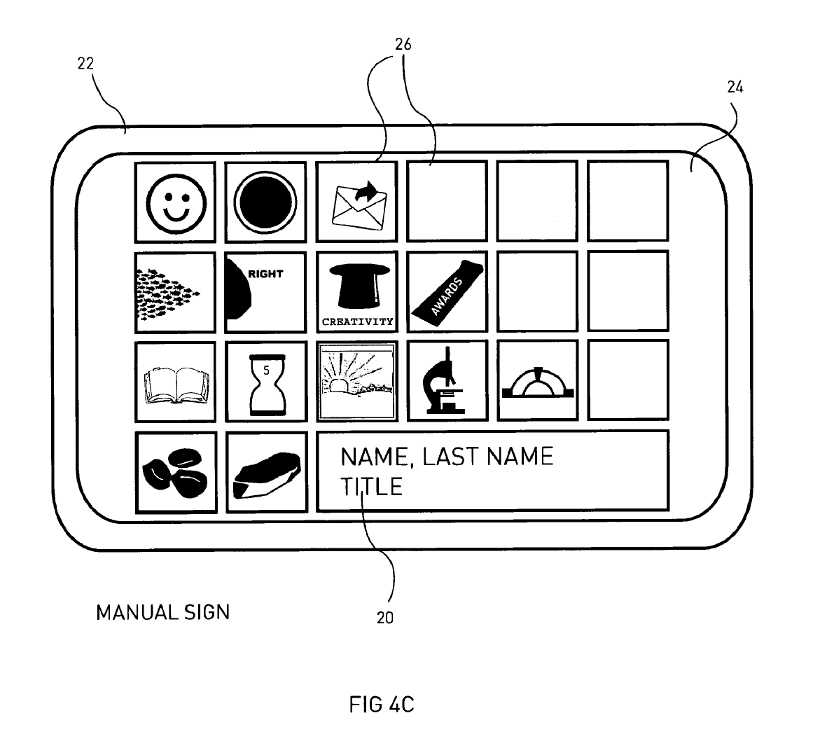

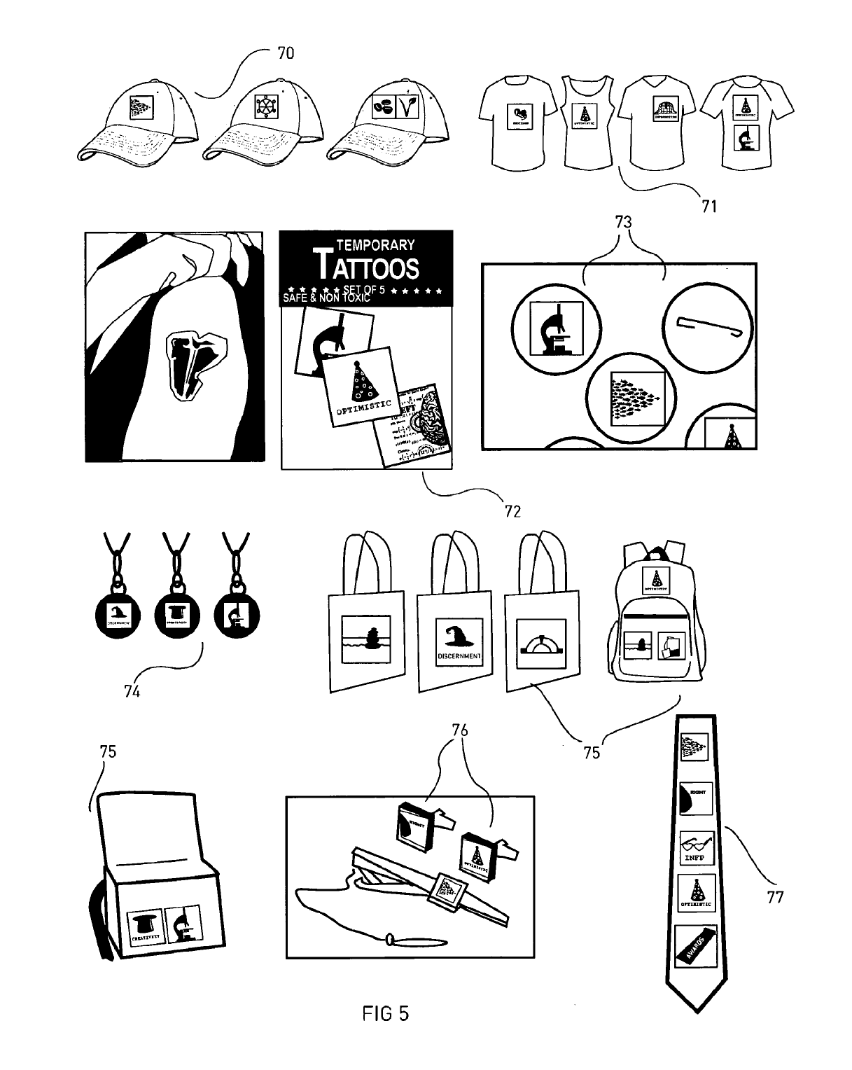

The data from employees on submissions, preferably through an online system as described in connection with FIGS. 2A through 2F, can then be utilized to generate physical sign apparatus or a network tablet style display that is displayed proximate the employee's work station, office or cubicle so that it may be perused by other company personnel who interface with the employee. Signage may take the form of a prepopulated but adaptable sign 10 as shown in FIG. 4A which includes a base plate 11 having a series of cutouts 12 behind which rotatable icon wheels 14 are mounted and rotated to display desired icons 16. Additional slots may be provided for selective mounting of additional icons 18 and employee identification information 20. A more simplified physical sign 21 with employee identification information 20 and spaces for five icons 16 is shown in FIG. 4B.

FIG. 4C illustrates a sign 22 with a plastic base plate 24 and a plurality of rectangular recesses in which resilient icon pieces 26 may be snapped, or removed. The information depicted on such a sign apparatus 22 may be substantially equivalent to the online representation 60 of FIG. 3A. The icons can be displayed in innumerable ways and characteristic of the method of the present invention is persistent and diverse use of personality reflective icons throughout an organization. For instance, icons may be included in all of the following, many of which are depicted in FIGS. 4 and 5:
Signs 10,21,22
Phone Systems 66
Tablets
Smartphones 62,64
Smartwatches
Mobile Business Card
Email Signatures
Databases, Directories, Filing & Grouping Systems
Employee Directories & Databases
Team Directories
Web Directories & Databases
Meeting Attendant Displays, Seminars, Reviews, Team Building
Retreats, Team Competitions
Displays, Identifiers and Apparel:
Caps, Hats 70
T-Shirts, Jackets, Clothes, Patches 71
Temporary Tattoos 72
Buttons, Badges, Ribbons 73
Charms 74
Coins
Badges, Backpacks, Packs, 75
Awards, Achievements, Certificates, Certifications
Pins, Cufflinks 76
Ties 77
Labels
Belt buckles, Cups, Key chains,

Use of personality indicators on a consistent and pervasive basis will keep individuals engaged with the guidance to utilize varying personality types to the organization's advantage.

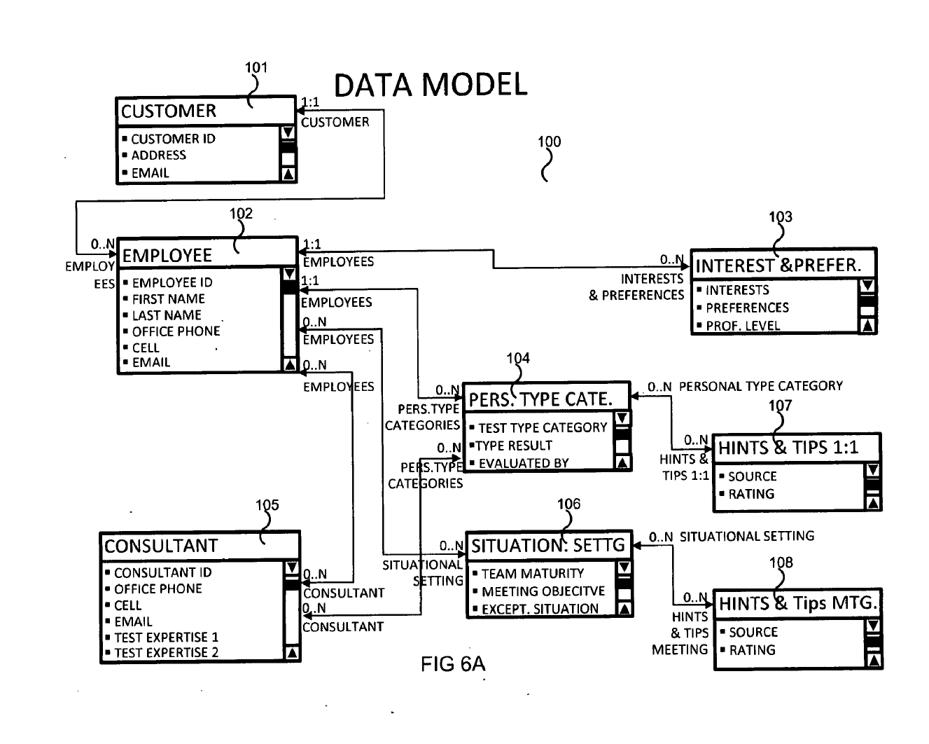

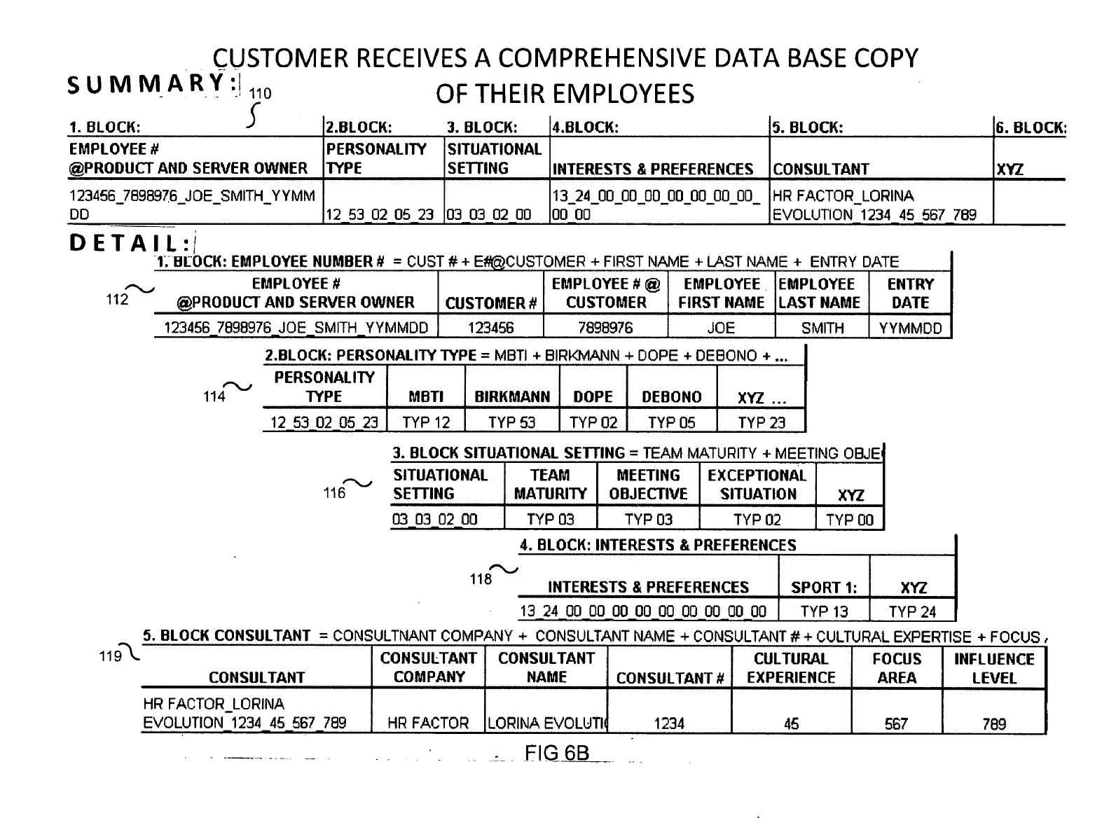

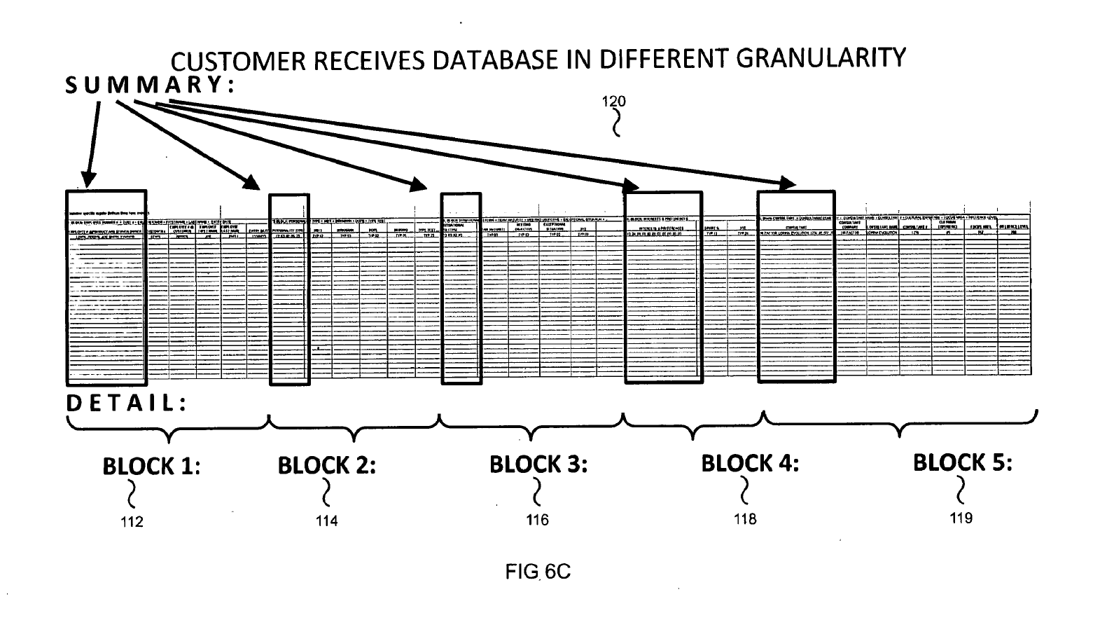

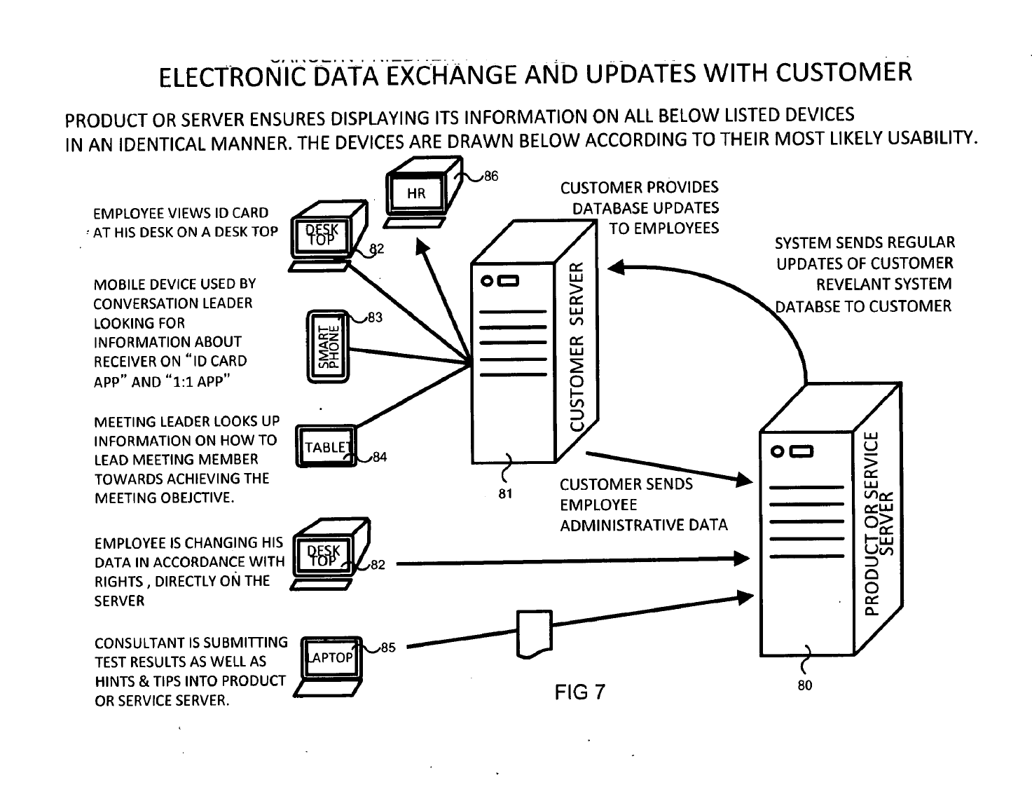

FIGS. 6 and 7 provide a high level view of an exemplary data structure and system for implementation of personality assessment and characteristics in a work place. In the data model depicted in FIG. 6A, there is employer or customer information 101 which is associated with employee administrative information 102. The employee administrative information 102 represents an employee's basic employment record and can be enhanced by additional information. Such information includes employee interests and preferences 103 that may be advantageously entered by the employees; personality type categorization 104 which is generally entered by a testing company, consultant, or employer human resources process after evaluating the employee. In addition, employees might be either automatically subscribed by their employer or exercise their discretion to monitor information from particular consultants. Consultants authorized to utilize the system have basic identifying information 105 and can be allowed to communicate with particular employees or personality type categories 104 providing hints and tips that may be accessed by employees. It is contemplated that at least two databases for hints and tips on dealing with various personality types and characteristics will be maintained. One of these databases focuses on one-to-one interactions between employees and is identified as Hints & Tips 1:1 107 and can be linked through the particular personality type categories 104 utilized by an employer. The second Hints & Tips database 108 is for use with groups and meetings and is designed to segregate Hints & Tips depending upon the composition and characteristics of the group. For instance, a group having its initial organizational meetings will behave differently than a mature team that has been working collaboratively for a year or more. Also, meetings may have different types of objectives and may be called to address exceptional situations requiring different motivations.

FIG. 6B provides an exemplary illustration of how this data may be broken down into five blocks 112,114,116,118,119. The first block 112 provides the employee administrative information linked to the employer information. The second block 114 includes personality assessment information and may include personality type information from several different commercial tests as well as employer specific, or “XYZ,” testing. A third block of information reflects different situational settings that may be applicable to group meetings. The fourth block of information reflects employees' individual interests and preferences, and this data can be maintained as employee owned information. The fifth block of information provides consultant administrative information. These five data blocks are further illustrated conceptually in FIG. 6C.

FIG. 7 provides a simplified architecture for implementation of a distributive personality assessment system. The principal components of the system are a system server 80 which is primarily responsible for coordinating the various databases: company employees segregated by company, consultants, employee entered information such as interests and preferences, and assorted hints and tips for addressing personality types both in one-on-one and group situations. The hints and tips will include both system owned/constructed hints and tips as well as third party consultant hints and tips which remain owned by the consultants or consultant customers as provided amongst themselves. The system database also maintains a structure for allocating hints and tips according to personality classification and according to various group characteristics. Thus, a consultant may provide specific hints and tips information to an individual team leader for a particular group or for whenever a team in a group has a particular personality type in a meeting with a particular situational setting such as meeting objective of “brainstorming.” A consultant may also address a particular tip to a specific leader to address a specific concern. However, if the tip relates to personality type, it will be classified within the system. The consultants will preferably interface through a system server 80 utilizing their laptop or work station 85 and the system server database will direct the consultant information to the appropriate personality types or group settings.

Employees will access the system both through their work stations 82 and mobile devices 83,84. Preferably, employees will be able to utilize a direct connection to the system to change their data within the scope of their user rights. In this fashion, an employee may update their preferences and interests and the system server will then repopulate that information in its database and update a customer or employer server 81. In connection with communications with the employer's server, employees will utilize three different applications. One is a simple ID app. The ID app is premised upon the concept of the information regarding the employee being owned by the employee. The employee can utilize the ID app to choose to display certain icons or not just as he can choose to display, or not, certain physical icons on his work space apparatus depicted in FIG. 4. The ID app is intended to display the same information as the physical sign and is in effect, an electronic personality type ID card for the employee. The employee can place this ID card on an electronic screen at his work space or distribute some or all of the components of the ID via another network such as maintained by a professional association or Linked In.

Employees also have access to a one-to-one app which enables a user to pull up information about another employee. It is anticipated that this app is used by a leader or conversation initiator to gain information and hints and tips for approaching a recipient employee about a request or needed collaboration. The one-to-one app provides information regarding the recipient's preferences and interests, and also preferred contact times and methods and hints and tips that provide elements to facilitate conversation, achieve constructive collaboration, and handle conflicts.

A third app or interface accessible to employees is an app which is geared for use by meeting leaders and others who may have the need of forming teams or addressing team dynamics, dealing with various personality types of team members in a meeting, overall characteristics of the team, and how to handle and steer meeting situations in order to achieve objectives considering the overall team maturity. The meeting app provides access to both universal hints regarding managing meetings with particular personality types and also individualized hints and tips that may be provided by particular consultants for specific teams.

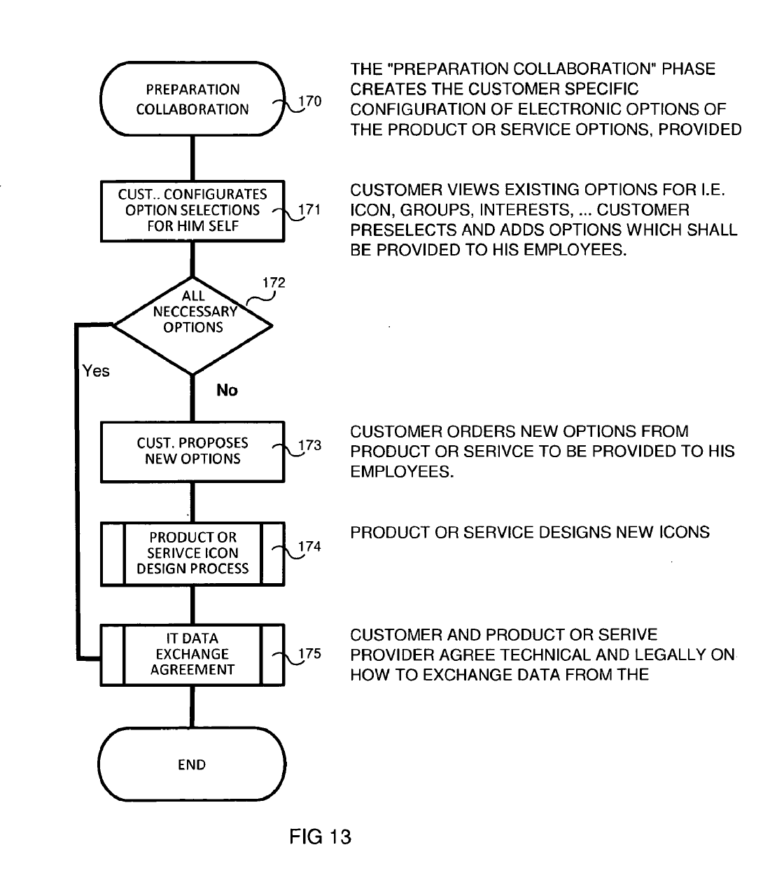

In practice, the employer will decide to implement the personality assessment type system and proceed through initial preparation and collaboration phase. In this phase, steps are taken to clarify the initial technical data transfer and there is collaboration to create a customer or employer specific configuration of options. The employer may select from existing system options or, if all necessary options are not available, request customization for additional options and possibly new icons to be provided to employees. Upon completion of this phase the employer agrees upon the technical and legal requirements applicable to the transfer data for participating employees. The initial data typically contains the employee administrative information from which the system creates employee ID profile sheets and generates a communication to employees. FIG. 13 illustrates the pre-data transfer collaboration commencing at step 170, and the customer selection of existing options in 171, and the negotiation and development of additional options and icons in steps 173,174.

Once the system has created an employee's ID profile record and generated an e-mail or link to the employee granting access to the employee's record on the system, the employee can input their preferences and interests directly to the system as illustrated in FIG. 7. The system then replicates or synchronizes these employee interests and preferences to the employer on a regular, if not nearly continuous, basis.

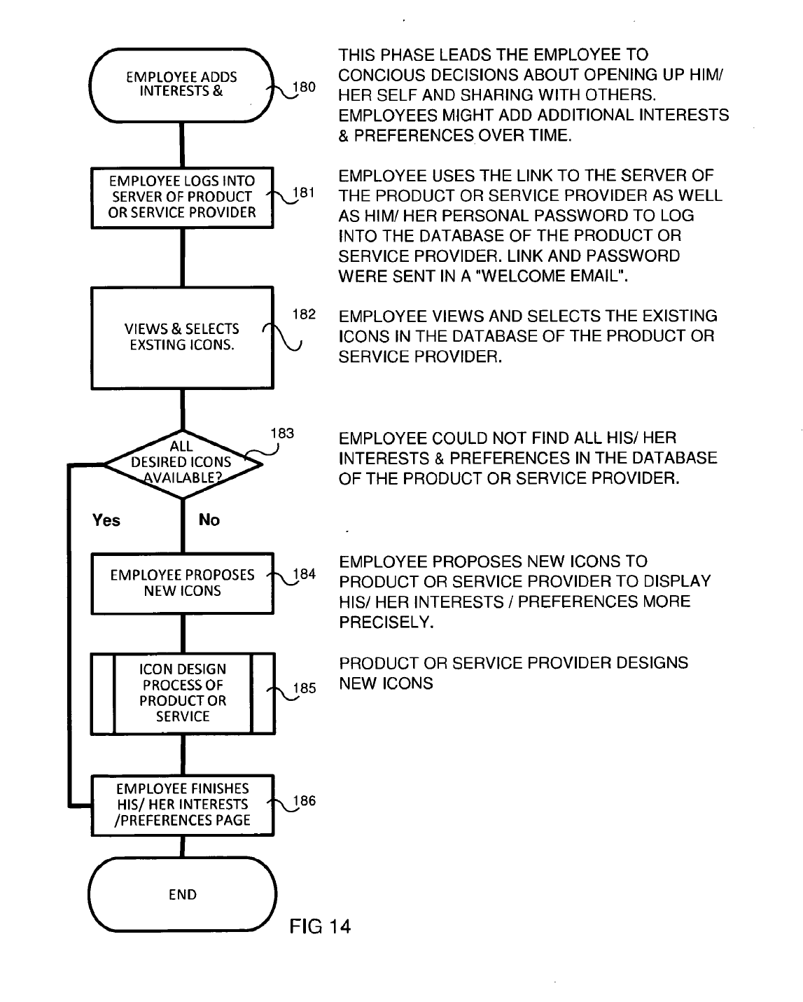

The process of employee entry of interests and preferences may give rise to further customization. As reflected in FIG. 14, when an employee adds interests and preferences by logging into the system server 181, the employee's initial review and selection of icons 182 may result in a perception that the options are insufficient. In that case, the employee may propose new icons 184 to be included in the system and those icons may be designed so long as this is within the scope of the employer's engagement with the system. Apart from customization and initial setup, employers may wish to add additional features or icons over time as corporate and employee interests evolve. Similarly, over time, employers may wish to delete certain interests should they become unpopular or be perceived as socially undesirable or tending to incite conflicts.

Employee personality type information is typically entered either by the corporate human resources or testing department 86 or by the administering third party consultant 85. Consultants, either within the employer or by outside arrangement, evaluate employees' personality dimension through testing and provide test results to every employee as well as hints and tips for leaders. The hints and tips are typically classified as universal hints and tips for leaders to use in one-to-one interactions, hints and tips to use in connection with group meetings; and individually tailored hints and tips for particular leaders in specific situations. The consultants retain the ability to maintain ownership of their hints and tips, at least to the extent that their contractual arrangements with employers do not transfer those rights.

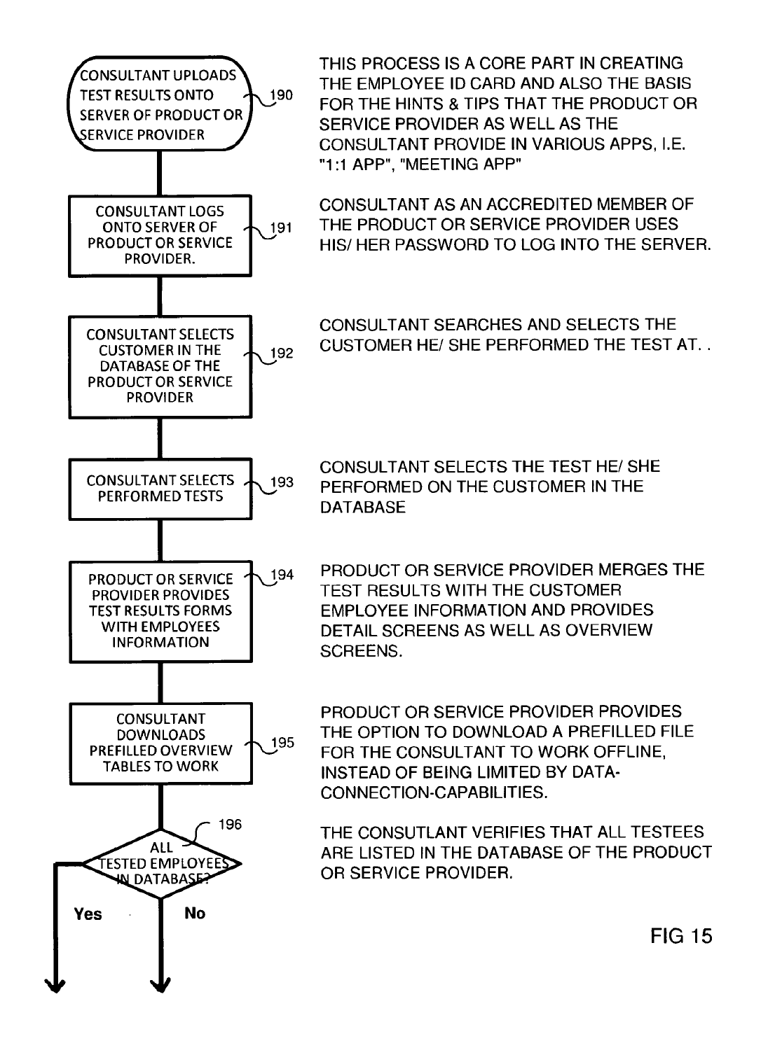

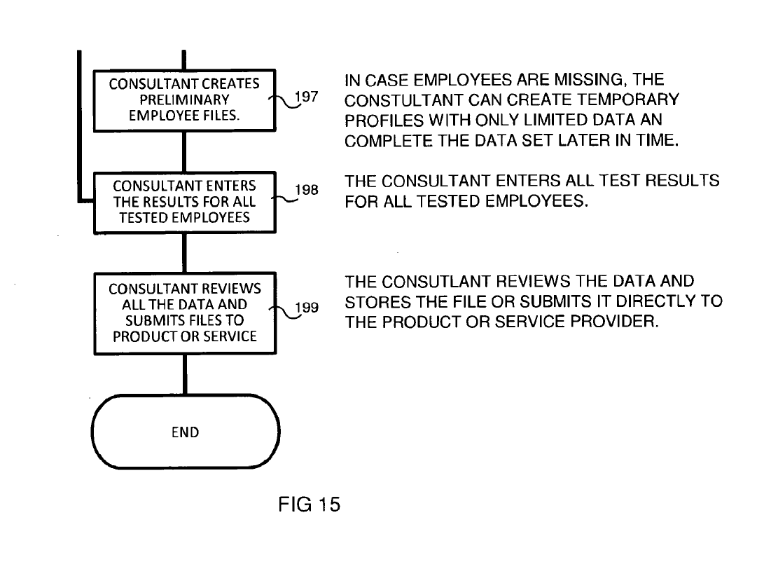

FIG. 15 is a flow chart of exemplary steps that would be taken by a consultant who had administered personality assessment tests. The consultant being previously accredited would log into the system server 191, select the employer or customer for whom testing had been performed, and then select the actual test performed from the system database. The consultant then provides data and the system merges test results into the appropriate employee information. The consultant can then download data to work off line. In addition, tools are provided to verify that data was correctly received for all tested employees.

It will be appreciated that the operational data sources and ownership of data, as well as security, are potentially critical features of an enhanced distributed personality assessment type system. Accordingly, Appendix 1 sets forth various data types included in an exemplary system, typical operational and original sources of the data, preferred techniques for entering data as well as the data owners and data handling that particular data types are subject to. This Appendix can be referenced for a detailed analysis of each data type.

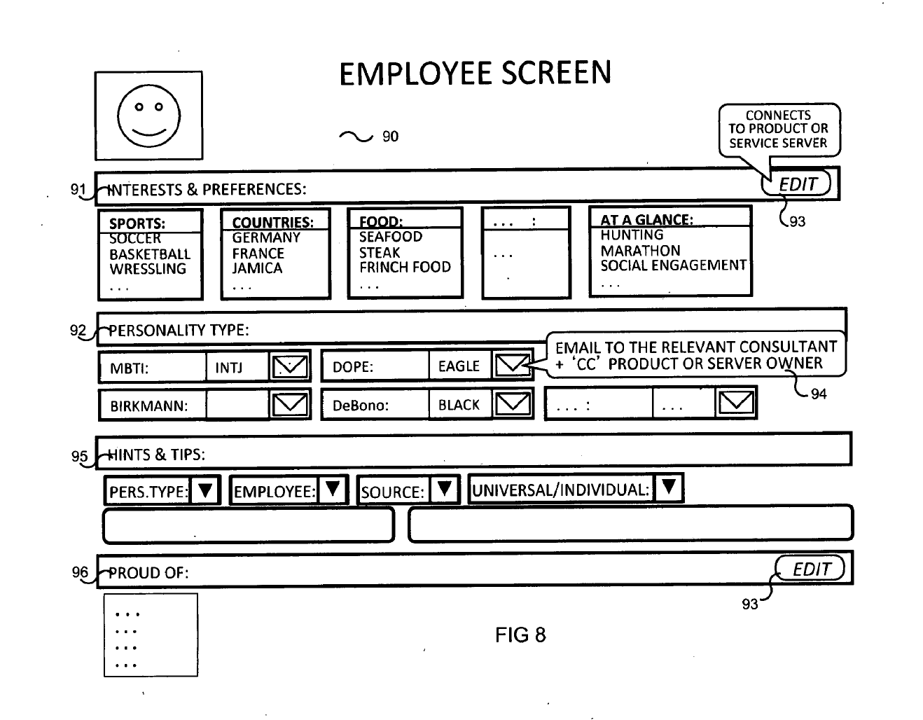

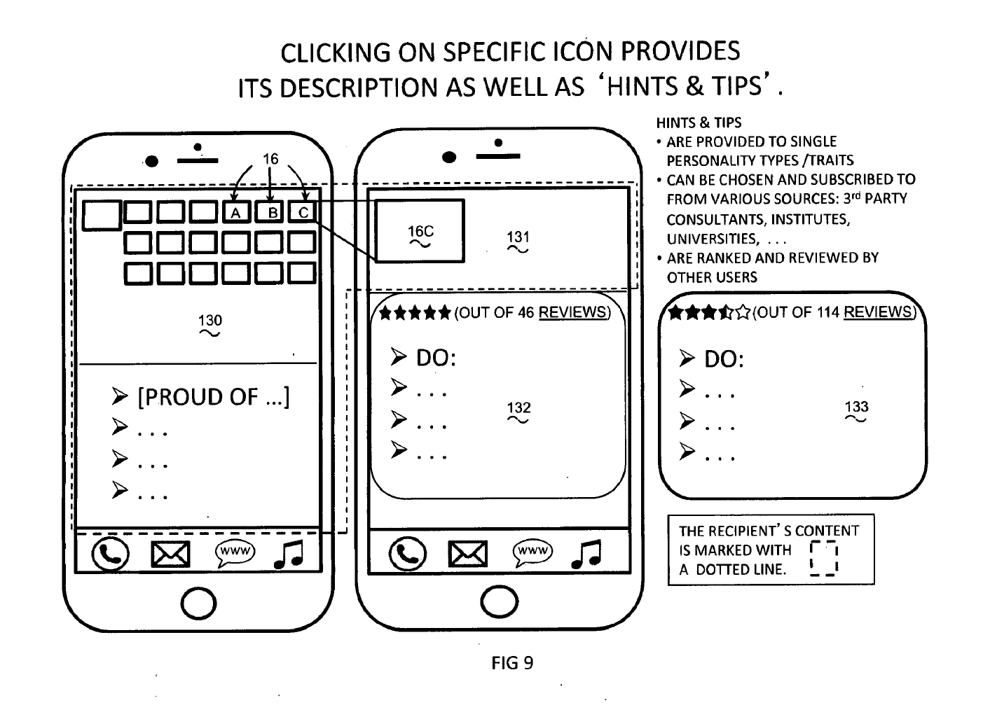

Turning then to FIG. 8, an employee access screen 90 is illustrated. Two of the illustrated sections, “Interests and Preferences” 91 and “Proud Of” 96 are intended to be employee editable. Thus, if an employee's interest in sports, for instance, should change, an edit link is provided so this information can be updated to the system server. In addition, the screen will contain a display of personality assessment types 92. This information is typically not authorized for employee editing, however, employees may be authorized to e-mail 94 relevant consultants either within or outside the employer, in any given instance. It is preferred that the consultation request and advice also pass through the system for overall monitoring and assimilation of data. In addition, employees have access to particular hints and tips 95. The hints and tips field 95 allows an employee to search for hints and tips by personality type, employee name, the source of hints and tips, the ability to recall the hints that were provided to the particular employee and whether the hints are universally applicable to the particular personality types. This makes the employee screen a limited functionality search tool in addition to a display and editing tool.

Another employee assistance program is illustrated as the 1:1 app in FIG. 9. This program is intended to be utilized by a conversation initiator or leader in a one-to-one setting. In an instance where the leader/employee is going to be making a request for assistance or collaboration from another previously unknown employee, the leader may access the request recipient's profile screen 130 which will contain a variety of icons indicating personality types and traits 16A,16B,16C. In the illustrated instance, the leader has been interested in personality trait 16C and by selecting that trait is provided with display 131 which describes the personality trait and provides access to hints and tips 132. Hints and tips may be provided from various sources, including the system's own database as well as various third party consultants or other authoritative sources. Preferably the sources, and consultant contributions, will be reviewed by other users to provide some indication of the likely reliability of the information.

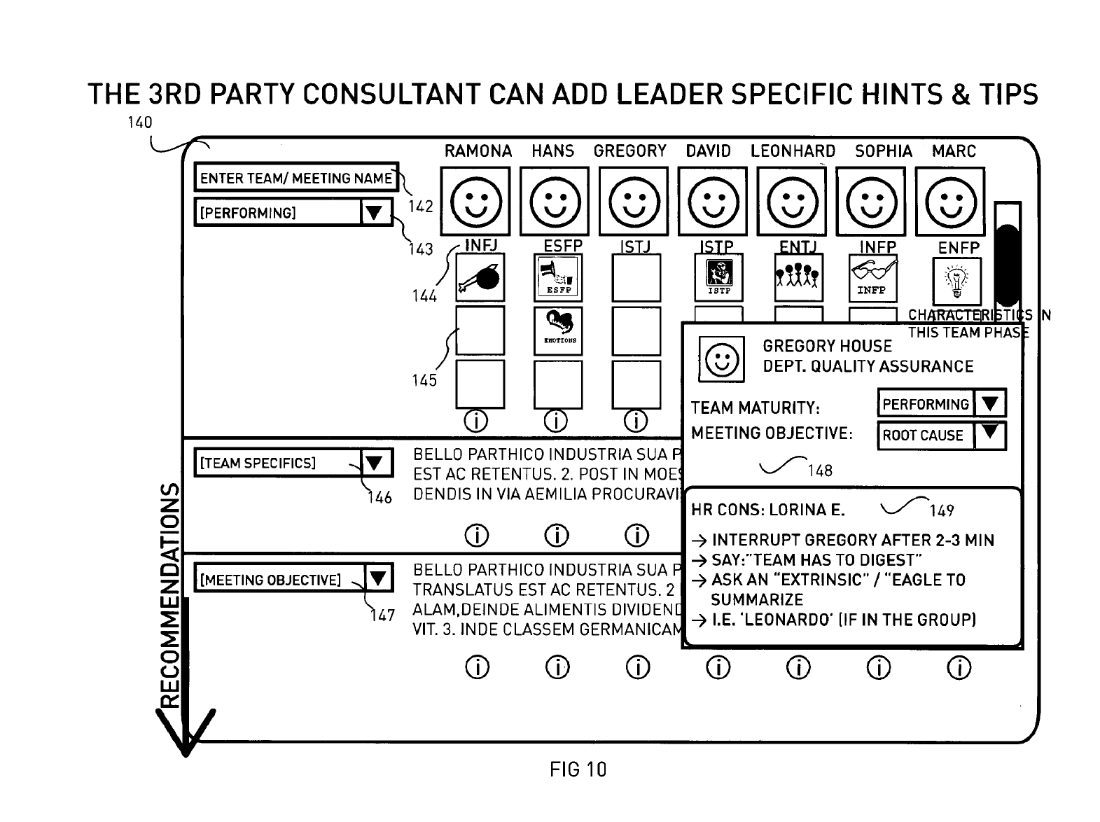

FIG. 10 is an illustration of an exemplary meeting leader screen 140. The meeting leader is able to prepare a composite illustration of a particular team, including entering a team name in field 142 and the team maturity level in field 143 (forming, norming, performing, etc.). Names and photographs of team members 141A,141B,141C may populate the screen as well as personality type 144 and primary, secondary, tertiary iconic indicators 145. The screen 140 allows for categorization of team specifics 146 and the team's objective 147 such as brainstorming, analysis, root cause, planning, risk-assessment, pro's and con's, operational details, change management, implementation, etc. Illustrated is an individualized hint and tip 148 containing information from an HR consultant 149 suggesting that the ISTJ personality type team member (Introvert, Sensing, Thinking, Judging) may need to be interrupted and an extrovert personality asked to summarize. In addition, other types of tips and hints may be provided such as suggestions to rearrange seating, how to ask a team optimist for an opinion, how to let extraverts take the lead and allow introverts to contribute at subsequent meetings, how to ask a team for creative solutions, allowing other team members to take the lead, which team members to ask for factual information and risk assessment information. The hints and tips are all provided based upon personality types as opposed to any individual's actual personality.

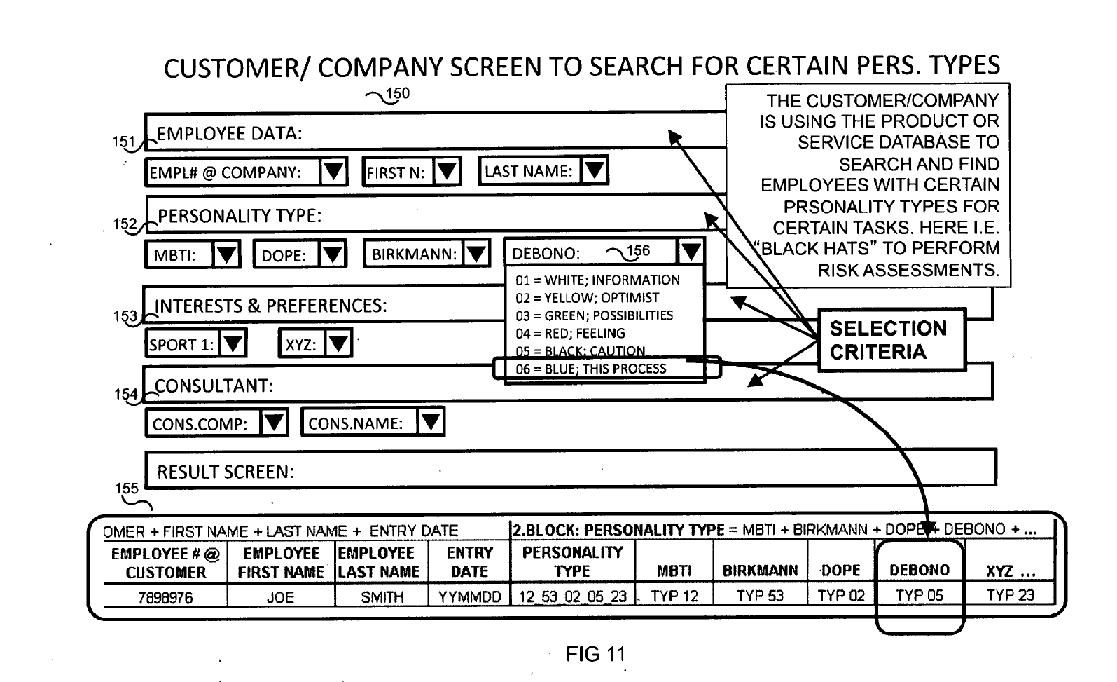

The employer is also provided with access to the system not only for the purposes of inputting data but also for the purposes of querying data. An exemplary customer screen 150 is illustrated in FIG. 11 which allows searching by employee data to locate particular individuals. It also allows searching by particular personality types according to various test classifications and the search under the DeBono 156 search for type 5 or black hat personality type is shown returning a result 155 in the results screen. Searches are also made by interests and preferences 153 and by consultants 154, illustrated with selections for consultant companies and consultant names. The searching provided to the employer may facilitate the creation of multi-department teams with appropriate balance or for the optimized replacement of team members who retire or move on to other employment.

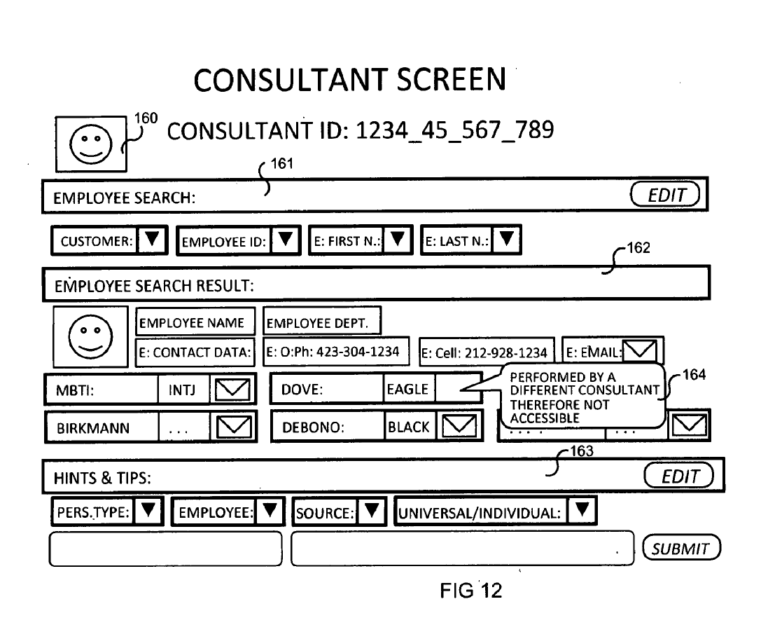

FIG. 12 depicts an exemplary consultant screen 160 which contemplates that consultants may need to search for individual employees utilizing an employee search function 161 enabling the consultant to specify the customer/employer as well as identifying information for the individual employee. The employee search result 162 discloses the basic employee administrative information as well as testing performed by the consultant. Testing performed by other consultants or otherwise not considered appropriate for access by a particular consultant may be limited as illustrated, 164. The consultant may also provide hints and tips. These hints and tips are structured to allow the consultant to classify the hints and tips by personality type, employee name, and as to whether the tips are directed to an individual or for universal application. These classification criteria will affect the fashion which the tip is indexed and stored in the system database.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

1. A method for the pervasive use of personality type information in an organization comprising the steps of:
assembling employee identification information and employee personality assessment information in a database of employee records;
having employees supplement the employee records with at least one of employee preferences and interests;
creating physical workplace displays for employees depicting graphic images corresponding to personality indicators derived from personality assessment information and at least one of communication preferences, conflict resolution preferences, and collaboration preferences;
conversation leaders and the employees within the organization viewing at least one of the physical workplace displays, interests, and preferences;
providing a database of tips for improving communication with a variety of personality types, said tips being classified by personality type;
organizing the tips by group maturity categorization;
the conversation leaders within the organization accessing the database of tips corresponding to the personality types of individuals with whom they intend to communicate.

2. The method of claim 1 wherein at least one outside consultant contributes to the database of tips for an organization.

3. The method of claim 1 wherein the database of tips is divided into tips for use by the conversation leader in one-to-one communication and tips for use in group meetings.

4. The method of claim 1 wherein the personality assessment information includes results from at least one personality test from the group comprising Myers-Briggs Type Indicator (MBTI), Caliper Profile, Hogan Assessments, StrengthsFinder, and DiSC, DeBono, DOPE, Birkman Method, Standout, Color Code, Personality Plus, 5 Love Languages, DOPE, Caliper Profile, Judgment Index, Predictive Index, firoB, 16PF, True Colors, Lerning Styles, PMAI, Big Five, Occupational Interest Inventories (OIIs), and Situational Judgment tests (STJs).

5. The method of claim 1 further comprising the organization utilizing a search of personality types for the purpose of selecting group members.

6. The method of claim 1 wherein employees are provided with at least one wearable item bearing an icon associated with at least one of communication preferences, conflict resolution preferences, and collaboration preferences.

7. The method of claim 2 wherein consultant contributions are evaluated and ranked.

8. The method of claim 2 wherein the consultant addresses a tip directly to an employee.

9. A system for implementing pervasive use of personality assessment information in the workplace comprising;
a database of employee identification information for individuals associated with the individuals' organization and personality type with said employee identification information;
a database of tips for dealing with personality types in one-to-one settings organized by personality type tests and type category;
a database of tips for dealing with personality types in groups organized by group maturity and objective; and
an interface to facilitate the organization searching individual records associated with the organization at least by employee identification information and personality type; and
an interface to facilitate the contribution of tips to at least one of said tip databases by a consultant.

10. The system of claim 9 wherein individuals employed with the organization are provided with an interface to enter their preferences and interests into a record associated with their employee identification information.

11. The system of claim 10 further comprising a physical display of icons corresponding to individual personality types and at least one interest or preference displayed by an individual in their work area.

12. The system of claim 9 further comprising a mobile software application to display profile records from selected employees in the organization and linking to tips for effective communication and collaboration with their indicated personality type.

13. The system of claim 10 further comprising a smartphone app distributed to individuals to display icons associated with their personality type and at least one interest or preference.

14. The system of claim 9 further comprising a group interface to display a plurality of employees' personality type information in tabular, iconic format.

15. The system of claim 14 wherein the group interface includes tips for communicating with group members' personality types.
